(19) United States
(12) Patent Application Publication
(10) Pub. No.: US 2026/0127083 A1
(43) Pub. Date: May 7, 2026

(54) Hardware Exerciser Having Variable-Length Runtime

(71) Applicant: INTERNATIONAL BUSINESS MACHINES CORPORATION, Armonk, NY (US)

(72) Inventors: John WIRTH, Austin, TX (US); Larry LEITNER, Austin, TX (US); John Alexander BYBEL, Austin, TX (US); Rosemary PEREZ, Austin, TX (US)

(21) Appl. No.: 18/940,681

(22) Filed: Nov. 7, 2024

(51) Int. Cl. G06F 11/22; G06F 11/34

(52) U.S. Cl. CPC G06F 11/2236; G06F 11/2273; G06F 11/3409

(57) ABSTRACT

A hardware exerciser can iteratively perform a plurality of runs of a first test case. For each of the plurality of runs of first test case, at least one performance metric indicating a respective performance of the microprocessor for the respective run can be determined. Responsive to completion of each of the plurality of respective runs of the first test case subsequent to a first run of the first test case, a difference between performance metric(s) determined for a most recent run of the first test case and the performance metric(s) determined for a previous run of the first test case can be determined. For a first most recent run of the first test case, responsive to the difference being greater than a first threshold value, running of the first test case on the microprocessor can be continued.

### BACKGROUND

The present invention relates to microprocessors, and more specifically, to hardware exercisers that perform microprocessor verification.

Hardware exercisers are useful for verifying microprocessor performance and functionality, both pre-silicon and post-silicon. A hardware exerciser runs test cases on the microprocessor, or microprocessor model, and outputs test results. The test results are analyzed to determine whether the microprocessor meets design expectations.

### SUMMARY

A method includes initiating, by a hardware exerciser executed by a processor, a microprocessor to iteratively perform a plurality of runs of a first test case. The method also can include, for each of the plurality of runs of the first test case, determining at least a first performance metric indicating a respective performance of the microprocessor for the respective run of the first test case. The method also can include, responsive to completion of each of the plurality of respective runs of the first test case subsequent to a first run of the first test case, determining a difference between the at least the first performance metric determined for a most recent run of the first test case and the at least the first performance metric determined for a previous run of the first test case The method also can include, for a first most recent run of the first test case, responsive to the difference, between the at least the first performance metric determined for the first most recent run of the first test case and the at least the first performance metric determined for a first previous run of the first test case, being greater than a first threshold value, continuing running the first test case on the microprocessor.

A system includes a processor set and one or more computer-readable storage media. The system also includes program instructions stored on the one or more storage media to cause the processor set to perform operations. The operations correspond to the described method.

A computer program product for variable-length runtime for a hardware exerciser includes one or more computer-readable storage media and program instructions stored on the one or more storage media to perform operations. The operations correspond to the described method.

This Summary section is provided merely to introduce certain concepts and not to identify any key or essential features of the claimed subject matter. Other features of the inventive arrangements will be apparent from the accompanying drawings and from the following detailed description.

### BRIEF DESCRIPTION OF THE DRAWINGS

FIG. 1 depicts a computing environment according to an embodiment of the present invention.

FIG. 2 depicts a microprocessor test environment according to an embodiment of the present invention.

FIG. 3 depicts a microprocessor test environment according to an embodiment of the present invention.

FIGS. 4A and 4B, together, depict a flowchart illustrating an example of a method of verifying a microprocessor performance.

### DETAILED DESCRIPTION

The arrangements described herein are directed to computer technology, and provide an improvement to computer technology. Specifically, the present arrangements improve microprocessor verification.

Typically, using a conventional hardware exerciser, an individual test case is generated and ran a fixed number of times on a microprocessor (e.g., a microprocessor model, a microprocessor integrated circuit chip and/or a microprocessor package). After the test case has been run the fixed number of times, a new test case is generated, and the new test case is ran a fixed number of times. This process repeats until a specified number of test cases are ran the specified number of times, and test results are analyzed. The number of test cases ran on a microprocessor may be in the range of twenty to fifty test cases.

During test case runs, there may be parameter values that are missed due to an insufficient number of test runs being specified for each test case. These parameter values may derive from microarchitectural differences in subsequent test case runs due to performance related structures (e.g., structures for branch prediction, cache allocation, etc.) being trained from earlier test case runs. Thus, a conventional hardware exerciser may provide inadequate test coverage for microprocessor verification.

A larger number of test case runs can be specified to be ran by the hardware exerciser, but generating test cases and running those test cases is both time intensive and hardware resource intensive for the processing system implementing the hardware exerciser. In this regard, generating and running test cases utilizes a significant amount of processor resources, memory resources and communication resources. Indeed, using a conventional hardware exerciser, generating test cases and running those test cases on a microprocessor model in a simulation farm can take several hours.

Microprocessor integrated circuit chips (hereinafter “chips”) typically are tested using a hardware exerciser prior to being attached to a printed circuit board of a microprocessor (e.g., in a microprocessor package). The tests can indicate whether chip cores meet specified criteria, the clock speeds that may be used for the chips, instructions per clock cycle (IPC) provided by the chips, which cores of the chips are functional, etc. This can be useful for binning the chips into different performance categories, which can determine into which products the chips are used. For example, an eight-core chip having two-cores that do not meet specification and/or are not functional can be used in a six-core microprocessor chip package. Further, chips can be allocated to different products based on the clock speeds at which the chips are capable of running.

Chips typically are manufactured in very large quantities. Using a conventional hardware exerciser for chip verification and binning can be time intensive, thus negatively impacting production efficiency. If an attempt is made to decrease the amount of time used for chip verification and binning by simply reducing the specified number of test cases and/or the number of fixed test case runs, the risk of chips that do not meet specified criteria may be increased, resulting in quality issues.

The inventive arrangements described herein overcome deficiencies of conventional hardware exercisers. Specifically, the present arrangements reduce the use of hardware resources for performing microprocessor validation, as well as reduce the amount of time spent on performing microprocessor validation, while providing adequate test coverage for microprocessor verification to ensure that microprocessors (e.g., microprocessor models, chips and/or microprocessor packages) meet specified criteria. The inventive arrangements accomplish this by dynamically determining, after each test case run, whether the test case has provided adequate test coverage. If adequate test coverage has not yet been provided by that test case, the test case can be run again. If, however, adequate coverage has been provided by that test case, the use of that test case can be determined to be complete, and that test case need not be run again. A next test case can be generated and ran in a similar manner, or the process can end if no further test cases are needed. A determination can be made that no additional test cases are needed responsive to a lapse of a specified duration of time for testing the microprocessor using test cases.

Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer-readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer-readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

Computing environment 100 contains an example of an environment for the execution of at least some of the computer code involved in performing the inventive methods, such as improved hardware exerciser 200. In addition to block 200, computing environment 100 includes, for example, computer 101, wide area network (WAN) 102, end user device (EUD) 103, remote server 104, public cloud 105, and private cloud 106. In this embodiment, computer 101 includes processor set 110 (including processing circuitry 120 and cache 121), communication fabric 111, volatile memory 112, persistent storage 113 (including operating system 122 and block 200, as identified above), peripheral device set 114 (including user interface (UI) device set 123, storage 124, and Internet of Things (IoT) sensor set 125), and network module 115. Remote server 104 includes remote database 130. Public cloud 105 includes gateway 140, cloud orchestration module 141, host physical machine set 142, virtual machine set 143, and container set 144.

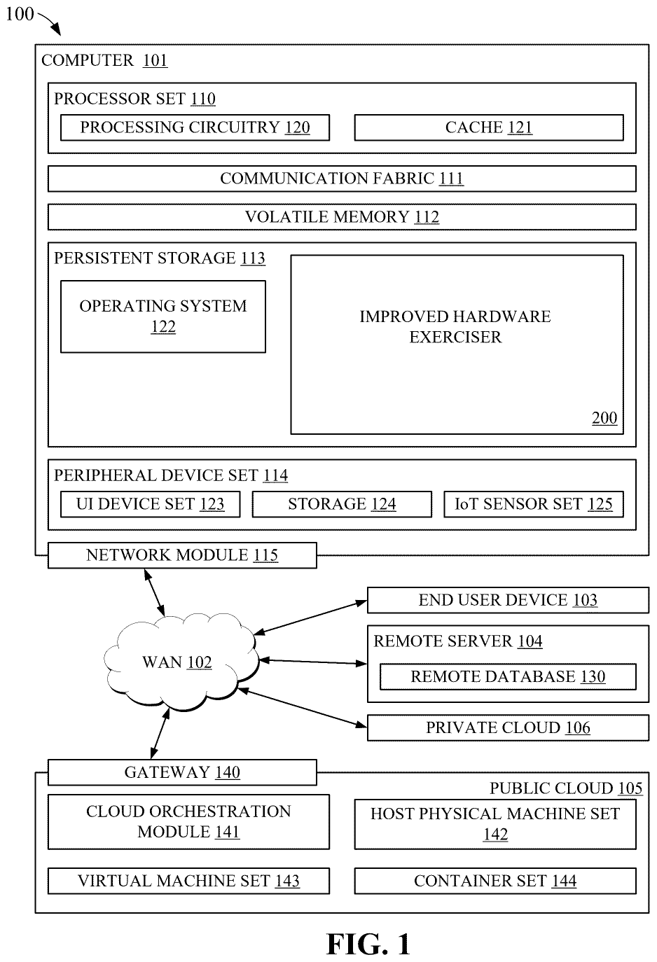

COMPUTER 101 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 130. As is well understood in the art of computer technology, and depending upon the technology, performance of a computer-implemented method may be distributed among multiple computers and/or between multiple locations. On the other hand, in this presentation of computing environment 100, detailed discussion is focused on a single computer, specifically computer 101, to keep the presentation as simple as possible. Computer 101 may be located in a cloud, even though it is not shown in a cloud in FIG. 1. On the other hand, computer 101 is not required to be in a cloud except to any extent as may be affirmatively indicated.

PROCESSOR SET 110 includes one, or more, computer processors of any type now known or to be developed in the future. Processing circuitry 120 may be distributed over multiple packages, for example, multiple, coordinated integrated circuit chips. Processing circuitry 120 may implement multiple processor threads and/or multiple processor cores. Cache 121 is memory that is located in the processor chip package(s) and is typically used for data or code that should be available for rapid access by the threads or cores running on processor set 110. Cache memories are typically organized into multiple levels depending upon relative proximity to the processing circuitry. Alternatively, some, or all, of the cache for the processor set may be located “off chip.” In some computing environments, processor set 110 may be designed for working with qubits and performing quantum computing.

Computer-readable program instructions are typically loaded onto computer 101 to cause a series of operational steps to be performed by processor set 110 of computer 101 and thereby effect a computer-implemented method, such that the instructions thus executed will instantiate the methods specified in flowcharts and/or narrative descriptions of computer-implemented methods included in this document (collectively referred to as “the inventive methods”). These computer-readable program instructions are stored in various types of computer-readable storage media, such as cache 121 and the other storage media discussed below. The program instructions, and associated data, are accessed by processor set 110 to control and direct performance of the inventive methods. In computing environment 100, at least some of the instructions for performing the inventive methods may be stored in block 200 in persistent storage 113.

COMMUNICATION FABRIC 111 is the signal conduction path that allows the various components of computer 101 to communicate with each other. Typically, this fabric is made of switches and electrically conductive paths, such as the switches and electrically conductive paths that make up buses, bridges, physical input/output ports and the like. Other types of signal communication paths may be used, such as fiber optic communication paths and/or wireless communication paths.

VOLATILE MEMORY 112 is any type of volatile memory now known or to be developed in the future. Examples include dynamic type random access memory (RAM) or static type RAM. Typically, volatile memory 112 is characterized by random access, but this is not required unless affirmatively indicated. In computer 101, the volatile memory 112 is located in a single package and is internal to computer 101, but, alternatively or additionally, the volatile memory may be distributed over multiple packages and/or located externally with respect to computer 101.

PERSISTENT STORAGE 113 is any form of non-volatile storage for computers that is now known or to be developed in the future. The non-volatility of this storage means that the stored data is maintained regardless of whether power is being supplied to computer 101 and/or directly to persistent storage 113. Persistent storage 113 may be a read only memory (ROM), but typically at least a portion of the persistent storage allows writing of data, deletion of data and re-writing of data. Some familiar forms of persistent storage include magnetic disks and solid state storage devices. Operating system 122 may take several forms, such as various known proprietary operating systems or open source Portable Operating System Interface-type operating systems that employ a kernel. The code included in block 200 typically includes at least some of the computer code involved in performing the inventive methods.

PERIPHERAL DEVICE SET 114 includes the set of peripheral devices of computer 101. Data communication connections between the peripheral devices and the other components of computer 101 may be implemented in various ways, such as Bluetooth connections, Near-Field Communication (NFC) connections, connections made by cables (such as universal serial bus (USB) type cables), insertion-type connections (for example, secure digital (SD) card), connections made through local area communication networks and even connections made through wide area networks such as the internet. In various embodiments, UI device set 123 may include components such as a display screen, speaker, microphone, wearable devices (such as goggles and smart watches), keyboard, mouse, printer, touchpad, game controllers, and haptic devices. Storage 124 is external storage, such as an external hard drive, or insertable storage, such as an SD card. Storage 124 may be persistent and/or volatile. In some embodiments, storage 124 may take the form of a quantum computing storage device for storing data in the form of qubits. In embodiments where computer 101 is required to have a large amount of storage (for example, where computer 101 locally stores and manages a large database) then this storage may be provided by peripheral storage devices designed for storing very large amounts of data, such as a storage area network (SAN) that is shared by multiple, geographically distributed computers. IoT sensor set 125 is made up of sensors that can be used in Internet of Things applications. For example, one sensor may be a thermometer and another sensor may be a motion detector.

NETWORK MODULE 115 is the collection of computer software, hardware, and firmware that allows computer 101 to communicate with other computers through WAN 102. Network module 115 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 115 are performed on the same physical hardware device. In other embodiments (for example, embodiments that utilize software-defined networking (SDN)), the control functions and the forwarding functions of network module 115 are performed on physically separate devices, such that the control functions manage several different network hardware devices. Computer-readable program instructions for performing the inventive methods can typically be downloaded to computer 101 from an external computer or external storage device through a network adapter card or network interface included in network module 115.

WAN 102 is any wide area network (for example, the internet) capable of communicating computer data over non-local distances by any technology for communicating computer data, now known or to be developed in the future. In some embodiments, the WAN 012 may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

END USER DEVICE (EUD) 103 is any computer system that is used and controlled by an end user (for example, a customer of an enterprise that operates computer 101), and may take any of the forms discussed above in connection with computer 101. EUD 103 typically receives helpful and useful data from the operations of computer 101. For example, in a hypothetical case where computer 101 is designed to provide a recommendation to an end user, this recommendation would typically be communicated from network module 115 of computer 101 through WAN 102 to EUD 103. In this way, EUD 103 can display, or otherwise present, the recommendation to an end user. In some embodiments, EUD 103 may be a client device, such as thin client, heavy client, mainframe computer, desktop computer and so on.

REMOTE SERVER 104 is any computer system that serves at least some data and/or functionality to computer 101. Remote server 104 may be controlled and used by the same entity that operates computer 101. Remote server 104 represents the machine(s) that collect and store helpful and useful data for use by other computers, such as computer 101. For example, in a hypothetical case where computer 101 is designed and programmed to provide a recommendation based on historical data, then this historical data may be provided to computer 101 from remote database 130 of remote server 104.

PUBLIC CLOUD 105 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economies of scale. The direct and active management of the computing resources of public cloud 105 is performed by the computer hardware and/or software of cloud orchestration module 141. The computing resources provided by public cloud 105 are typically implemented by virtual computing environments that run on various computers making up the computers of host physical machine set 142, which is the universe of physical computers in and/or available to public cloud 105. The virtual computing environments (VCEs) typically take the form of virtual machines from virtual machine set 143 and/or containers from container set 144. It is understood that these VCEs may be stored as images and may be transferred among and between the various physical machine hosts, either as images or after instantiation of the VCE. Cloud orchestration module 141 manages the transfer and storage of images, deploys new instantiations of VCEs and manages active instantiations of VCE deployments. Gateway 140 is the collection of computer software, hardware, and firmware that allows public cloud 105 to communicate through WAN 102.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

PRIVATE CLOUD 106 is similar to public cloud 105, except that the computing resources are only available for use by a single enterprise. While private cloud 106 is depicted as being in communication with WAN 102, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 105 and private cloud 106 are both part of a larger hybrid cloud.

CLOUD COMPUTING SERVICES AND/OR MICROSERVICES (not separately shown in FIG. 1): private and public clouds 106 are programmed and configured to deliver cloud computing services and/or microservices (unless otherwise indicated, the word “microservices” shall be interpreted as inclusive of larger “services” regardless of size). Cloud services are infrastructure, platforms, or software that are typically hosted by third-party providers and made available to users through the internet. Cloud services facilitate the flow of user data from front-end clients (for example, user-side servers, tablets, desktops, laptops), through the internet, to the provider's systems, and back. In some embodiments, cloud services may be configured and orchestrated according to as “as a service” technology paradigm where something is being presented to an internal or external customer in the form of a cloud computing service. As-a-Service offerings typically provide endpoints with which various customers interface. These endpoints are typically based on a set of APIs. One category of as-a-service offering is Platform as a Service (PaaS), where a service provider provisions, instantiates, runs, and manages a modular bundle of code that customers can use to instantiate a computing platform and one or more applications, without the complexity of building and maintaining the infrastructure typically associated with these things. Another category is Software as a Service (SaaS) where software is centrally hosted and allocated on a subscription basis. SaaS is also known as on-demand software, web-based software, or web-hosted software. Four technological sub-fields involved in cloud services are: deployment, integration, on demand, and virtual private networks.

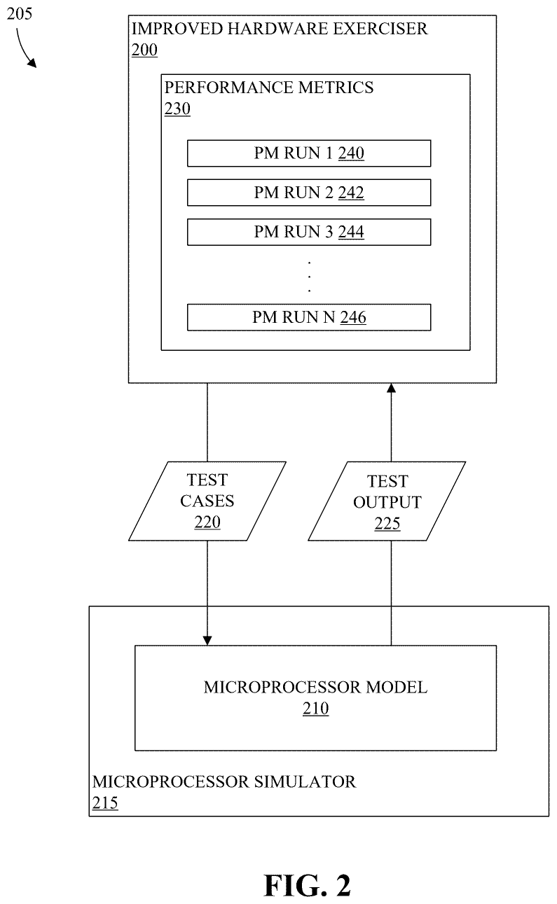

FIG. 2 depicts a microprocessor test environment 205 according to an embodiment of the present invention. Microprocessor test environment 205 can be used to test a microprocessor by testing a model of the microprocessor, microprocessor model 210, in a microprocessor simulator 215.

Improved hardware exerciser 200 can generate a test case 220 for testing microprocessor model 210. Improved hardware exerciser 200 can interface with microprocessor simulator 215, e.g., via public cloud 105 and/or private cloud 106, and initiate microprocessor model 210 to run (i.e., execute) test case 220. Running test case 220, microprocessor model 210 can generate at least one output, and communicate the at least one output to improved hardware exerciser 200 as test output 225 for the first run. Based on test output 225, improved hardware exerciser 200 can determine one or more performance metrics 230 for that run of test case 220, and store those performance metrics as performance metrics 240. In illustration, a performance metric 230 can be the amount of time it took for microprocessor model 210 to run test case 220, for instance a total runtime. Other examples of performance metrics 230 improved hardware exerciser 200 can determine include, but are not limited to, instructions per clock cycle, branch misprediction, cache misses, inter-process communication, etc.

Responsive to microprocessor model 210 completing the run of test case 220, improved hardware exerciser 200 can interface with microprocessor simulator 215 and initiate microprocessor model 210 to again run test case 220. Again, running test case 220, microprocessor model 210 can generate at least one output, and communicate the at least one output to improved hardware exerciser 200 as test output 225 for the present run. Based on test output 225, improved hardware exerciser 200 can determine one or more performance metrics 230 for that run of test case 220, and store those performance metrics as performance metrics 242.

Responsive to each test case run being completed, improved hardware exerciser 200 can compare the performance metrics 230 for different runs. The different runs that are compared can be successive runs. For example, after the second run of the test case 220, improved hardware exerciser 200 can compare performance metrics 242 generated from the second run to performance metrics 240 generated from the first run of the test case 220. Responsive to that comparison revealing at least one performance metric that differs from one run to another by at least a threshold value, improved hardware exerciser 200 can initiate another run of the test case 220 by microprocessor model 210. The threshold value can be, for example, an absolute value of a percentage of difference.

In illustration, for each performance metric, improved hardware exerciser 200 can compare a first value of that performance metric generated for a previous test case run to a second value of that performance metric generated for a most recent test case run, and determine a difference between the first value and the second value. The difference can be an absolute value If the absolute value of that difference exceeds the threshold value by at least a threshold percentage of the first value or the second value, improved hardware exerciser 200 can determine that the performance metric differs from one run to another by at least the threshold value.

Improved hardware exerciser 200 can reiterate runs of the test case 220, generating performance metrics 244 through 246, until a comparison reveals that there is not at least one performance metric that differs from one run to another by at least the threshold value. The circumstance in which deviation of the performance metrics from one run to another is below a threshold level can indicate that performance related structures (e.g., structures for branch prediction, cache allocation, etc.) of microprocessor model 210 that are exercised by the test case 220 have been sufficiently warmed up (e.g., branch prediction has been sufficiently trained, caches are sufficiently pre-loaded with data, etc.) for the test case 220. After performance related structures of microprocessor model 210 are sufficiently warmed up for a test case 220, the benefit of again running that test case 220 on microprocessor model 210 decreases; there is a decrease in probability that additional runs of that test case 220 on microprocessor model 210 will provide additional information that is useful for analysis.

Responsive improved hardware exerciser 200 determining that the comparison reveals that there is not at least one performance metric that differs from one run to another by at least the threshold value, improved hardware exerciser 200 can discontinue runs of that test case 220. Accordingly, the arrangements described herein avoid running test cases 220 more times than necessary to acquire the information useful for analysis. This not only significantly reduces the amount of time spent running test cases 220, but also significantly reduces the use of hardware resources of computer 101 used to run test cases 220. In illustration, processor usage is reduced, memory usage is reduced, network usage is reduced, etc.

Improved hardware exerciser 200 can generate another test case 220 and run that test case 220, or discontinue testing of microprocessor model 210 using test cases 220. In one or more non-limiting arrangements, improved hardware exerciser 200 can discontinue testing of microprocessor model 210 using test cases 220 responsive to a specified duration of time elapsing. The specified duration of time can be a duration of time specified for testing microprocessor model 210.

To generate a new test case 220, improved hardware exerciser 200 can access a test case template and use a large randomly generated number to populate the test case template. For example, improved hardware exerciser 200 can populate the test case with values derived from the randomly generated number. Generating test cases can take significantly more time to generate than to run the test cases. By discontinue testing of microprocessor model 210 using test cases 220 responsive to a specified duration of time elapsing, the present arrangements can reduce the number of test cases 220 that are generated. This saves not only time for testing microprocessor model 210, but also reduces usage of hardware resources to perform the testing.

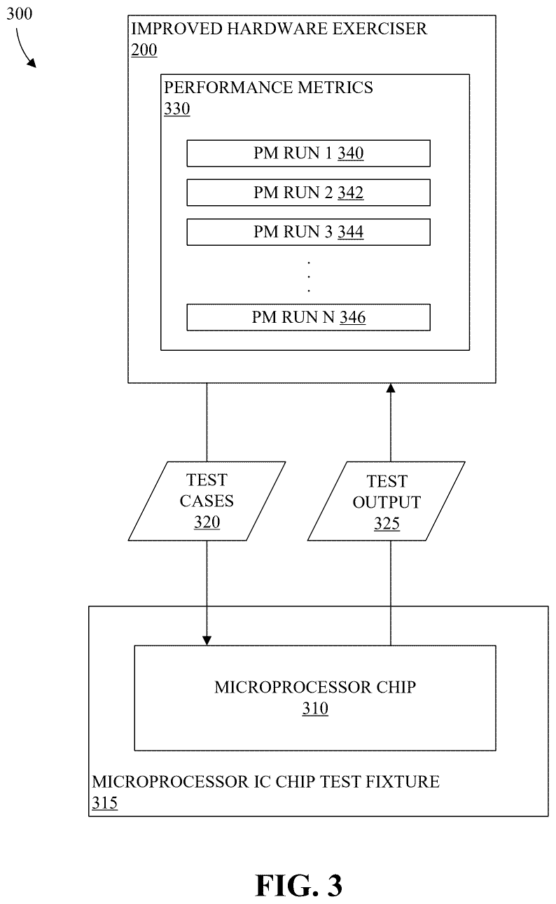

FIG. 3 depicts a microprocessor test environment 300 according to an embodiment of the present invention. Microprocessor test environment 300 can be used to test a microprocessor by testing a chip for the microprocessor, microprocessor chip 310, using a microprocessor integrated chip test fixture (hereinafter “test fixture”) 315.

Improved hardware exerciser 200 can test microprocess chip 310 before microprocessor chip 310 is integrated into a microprocessor package, or after microprocessor chip 310 is integrated into a microprocessor package. In this regard, test fixture 315 can be configured to interface directly with microprocessor chip 310 and/or configured to interface with microprocessor chip 310 via the microprocessor package. In illustration, test fixture 315 can include a socket for communicatively linking improved hardware exerciser 200 to microprocessor chip 310 and/or a socket communicatively linking improved hardware exerciser 200 to the microprocessor package. In an arrangement in which improved hardware exerciser 200 tests microprocessor chip 310 after microprocessor chip 310 is integrated into the microprocessor package, improved hardware exerciser 200 can test other components of the microprocessor package, for example cache external to microprocessor chip 310.

Improved hardware exerciser 200 can generate a test case 320 for testing microprocessor chip 310. Improved hardware exerciser 200 can interface with test fixture 315, e.g., via public cloud 105 and/or private cloud 106, and initiate microprocessor chip 310 to run (i.e., execute) test case 320. Running test case 320, microprocessor chip 310 can generate at least one output, and communicate the at least one output to improved hardware exerciser 200 as test output 325 for the first run. Based on test output 325, improved hardware exerciser 200 can determine one or more performance metrics 330 for that run of test case 320, and store those performance metrics as performance metrics 340. In illustration, a performance metric 330 can be the amount of time it took for microprocessor chip 310 to run test case 320, for instance a total runtime. Other examples of performance metrics 330 improved hardware exerciser 200 can determine include, but are not limited to, instructions per clock cycle, branch misprediction, cache misses, inter-process communication, etc.

Responsive to microprocessor chip 310 completing the run of test case 320, improved hardware exerciser 200 can interface with test fixture 315 and initiate microprocessor chip 310 to again run test case 320. Again, running test case 320, microprocessor chip 310 can generate at least one output, and communicate the at least one output to improved hardware exerciser 200 as test output 325 for the present run. Based on test output 325, improved hardware exerciser 200 can determine one or more performance metrics 330 for that run of test case 320, and store those performance metrics as performance metrics 342.

Responsive to each test case run being completed, improved hardware exerciser 200 can compare the performance metrics 330 for different runs. The different runs that are compared can be successive runs. For example, after the second run of the test case 320, improved hardware exerciser 200 can compare performance metrics 342 generated from the second run to performance metrics 340 generated from the first run of the test case 320. Responsive to that comparison revealing at least one performance metric that differs from one run to another by at least a threshold value, improved hardware exerciser 200 can initiate another run of the test case 320 by microprocessor chip 310. The threshold value can be, for example, an absolute value of a percentage of difference.

In illustration, for each performance metric, improved hardware exerciser 200 can compare a first value of that performance metric generated for a previous test case run to a second value of that performance metric generated for a most recent test case run, and determine a difference between the first value and the second value. The difference can be an absolute value. If the difference exceeds the threshold value by at least a threshold percentage of the first value or the second value, improved hardware exerciser 200 can determine that the performance metric differs from one run to another by at least the threshold value.

Improved hardware exerciser 200 can reiterate runs of the test case 320, generating performance metrics 344 through 346, until a comparison reveals that there is not at least one performance metric that differs from one run to another by at least the threshold value. The circumstance in which deviation of the performance metrics from one run to another is below a threshold level can indicate that performance related structures (e.g., structures for branch prediction, cache allocation, etc.) of microprocessor chip 310 that are exercised by the test case 320 have been sufficiently warmed up (e.g., branch prediction has been sufficiently trained, caches are sufficiently pre-loaded with data, etc.) for the test case 320. After performance related structures of microprocessor chip 310 are sufficiently warmed up for a test case 320, the benefit of again running that test case 320 on microprocessor chip 310 decreases; there is a decrease in probability that additional runs of that test case 320 on microprocessor chip 310 will provide additional information that is useful for analysis.

Responsive improved hardware exerciser 200 determining that the comparison reveals that there is not at least one performance metric that differs from one run to another by at least the threshold value, improved hardware exerciser 200 can discontinue runs of that test case 320. Accordingly, the arrangements described herein avoid running test cases 320 more times than necessary to acquire the information useful for analysis. This not only significantly reduces the amount of time spent running test cases 320, but also significantly reduces the use of hardware resources of computer 101 used to run test cases 320. In illustration, processor usage is reduced, memory usage is reduced, network usage is reduced, etc.

Improved hardware exerciser 200 can generate another test case 320 and run that test case 320, or discontinue testing of microprocessor chip 310 using test cases 320. In one or more non-limiting arrangements, improved hardware exerciser 200 can discontinue testing of microprocessor chip 310 using test cases 320 responsive to a specified duration of time elapsing. The specified duration of time can be a duration of time specified for testing microprocessor chip 310.

To generate a new test case 320, improved hardware exerciser 200 can access a test case template and use a large randomly generated number to populate the test case template. For example, improved hardware exerciser 200 can populate the test case template with values derived from the randomly generated number. As noted, generating test cases can take significantly more time to generate than to run the test cases. By discontinue testing of microprocessor chip 310 using test cases 220 responsive to a specified duration of time elapsing, the present arrangements can reduce the number of test cases 220 that are generated. This saves not only time for testing microprocessor chip 310, but also reduces usage of hardware resources to perform the testing.

FIGS. A and 4B, together, depict a flowchart illustrating an example of a method 400 of verifying a microprocessor performance. Method 400 can be implemented by improved hardware exerciser 200.

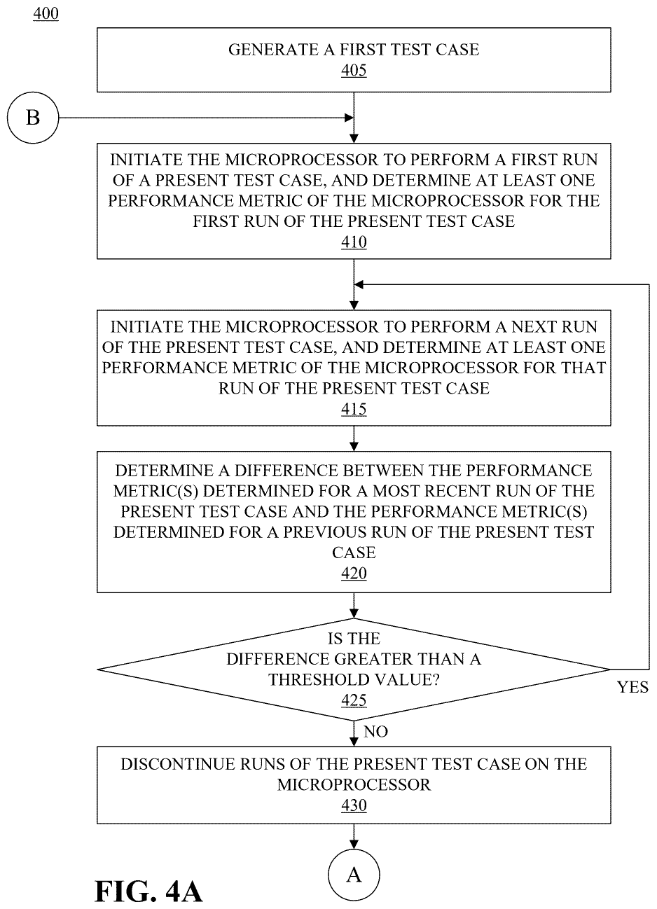

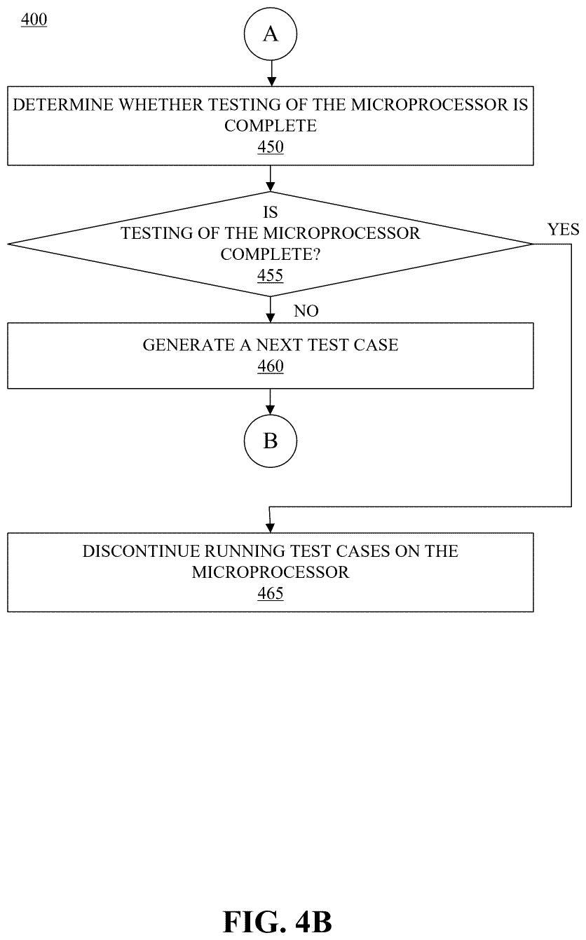

Referring to FIG. 4A, at step 405 improved hardware exerciser 200 can generate a first test case 220, 315 for a microprocessor, e.g., microprocessor model 210 or microprocessor chip 310.

At step 410 improved hardware exerciser 200 can initiate the microprocessor to perform a first run of a present test case, and determine at least one performance metric of the microprocessor for the first run of the present test case.

At step 415 improved hardware exerciser 200 can initiate the microprocessor to perform a next run of the present test case, and determine at least one performance metric of the microprocessor for the next run of the present test case.

At step 420 improved hardware exerciser 200 can determine a difference between the performance metric(s) determined for a most recent run of the present test case and the performance metric(s) determined for a previous run of the present test case. In illustration, for the second run of the present test case, improved hardware exerciser 200 can determine a difference between the performance metric(s) determined for second run of the present test case and the performance metric(s) determined for the first run of the present test case. For a third run of the present test case, improved hardware exerciser 200 can determine a difference between the performance metric(s) determined for third run of the present test case and the performance metric(s) determined for the second run of the present test case, and so on.

Referring to decision box 425, responsive to the difference being greater than a threshold value, improved hardware exerciser 200 can return to step 415 and initiate the microprocessor to perform a next run of the present test case, and determine at least one performance metric of the microprocessor for the next run of the present test case. On the other hand, responsive to the difference not being greater than the threshold value, improved hardware exerciser 200 can proceed to step 430.

At step 430 improved hardware exerciser 200 can discontinue runs of the present test case on the microprocessor.

Proceeding to FIG. 4B, at step 450 improved hardware exerciser 200 can determine whether testing of the microprocessor is complete. For example, improved hardware exerciser can determine whether a specified duration of time for testing the microprocessor using test cases has elapsed.

Referring to decision box 455, responsive to improved hardware exerciser 200 determining that testing of the microprocessor is not complete, at step 460 improved hardware exerciser 200 can generate a next test case. Responsive to generating the next test case, improved hardware exerciser 200 can proceed back to step 410. Improved hardware exerciser 200 can iterate steps/decision boxes 410-460 until improved hardware exerciser 200 determines, at decision box 455, that testing of the microprocessor is complete. Responsive to improved hardware exerciser 200 determining that testing of the microprocessor is complete, at step 465 improved hardware exerciser 200 can discontinue running test cases on the microprocessor.

Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

Several definitions that apply throughout this document will now be presented.

As defined herein, the term “microprocessor” means a microprocessor model and/or a microprocessor chip.

As defined herein, the term “test case” means a set of actions configured to be performed by a microprocessor to determine whether the microprocessor satisfies performance requirements and/or functions properly.

As defined herein, the term “performance metric” means a metric that indicates at least one aspect of performance of a microprocessor.

As defined herein, the term “run” means to execute an instance of a test case by a microprocessor.

As defined herein, the term “test run” means a single instance of running a test case by a microprocessor.

As defined herein, the term “responsive to” means responding or reacting readily to an action or event. Thus, if a second action is performed “responsive to” a first action, there is a causal relationship between an occurrence of the first action and an occurrence of the second action, and the term “responsive to” indicates such causal relationship.

As defined herein, the term “output” means storing in memory elements, writing to display or other peripheral output device, sending or transmitting to another system, exporting, or similar operations.

As defined herein, the term “automatically” means without user intervention.

What is claimed is:

1. A method, comprising:
initiating, by a hardware exerciser executed by a processor, a microprocessor to iteratively perform a plurality of runs of a first test case;
for each of the plurality of runs of the first test case, determining at least a first performance metric indicating a respective performance of the microprocessor for the respective run of the first test case;
responsive to completion of each of the plurality of respective runs of the first test case subsequent to a first run of the first test case, determining a difference between the at least the first performance metric determined for a most recent run of the first test case and the at least the first performance metric determined for a previous run of the first test case; and
for a first most recent run of the first test case, responsive to the difference, between the at least the first performance metric determined for the first most recent run of the first test case and the at least the first performance metric determined for a first previous run of the first test case, being greater than a first threshold value, continuing running the first test case on the microprocessor.

2. The method of claim 1, further comprising:
for a second most recent run of the first test case, responsive to the difference, between the at least the first performance metric determined for the second most recent run of the first test case and the at least the first performance metric determined for a second previous run of the first test case, not being greater than the first threshold value, discontinuing runs of the first test case on the microprocessor.

3. The method of claim 2, further comprising:
for the second most recent run of the first test case, determining the first most recent run of the first test case to be the second previous run of the first test case.

4. The method of claim 2, further comprising:
responsive to determining to discontinue runs of the first test case on the microprocessor, automatically generating, by the hardware exerciser, a second test case and initiating the microprocessor to iteratively perform a plurality of runs of the second test case.

5. The method of claim 1, further comprising:
responsive to determining that a specified duration of time for testing the microprocessor using the test cases has elapsed, discontinuing running the test cases on the microprocessor.

6. The method of claim 1, wherein the microprocessor is a microprocessor model.

7. The method of claim 1, wherein the microprocessor is a microprocessor chip.

8. A computer system, comprising:
a processor set;
one or more computer-readable storage media; and
program instructions stored on the one or more storage media to cause the processor set to perform operations comprising:
initiating, by a hardware exerciser, a microprocessor to iteratively perform a plurality of runs of a first test case;
for each of the plurality of runs of the first test case, determining at least a first performance metric indicating a respective performance of the microprocessor for the respective run of the first test case;
responsive to completion of each of the plurality of respective runs of the first test case subsequent to a first run of the first test case, determining a difference between the at least the first performance metric determined for a most recent run of the first test case and the at least the first performance metric determined for a previous run of the first test case; and
for a first most recent run of the first test case, responsive to the difference, between the at least the first performance metric determined for the first most recent run of the first test case and the at least the first performance metric determined for a first previous run of the first test case, being greater than a first threshold value, continuing running the first test case on the microprocessor.

9. The computer system of claim 8, wherein the operations further comprise:
for a second most recent run of the first test case, responsive to the difference, between the at least the first performance metric determined for the second most recent run of the first test case and the at least the first performance metric determined for a second previous run of the first test case, not being greater than the first threshold value, discontinuing runs of the first test case on the microprocessor.

10. The computer system of claim 9 wherein the operations further comprise:
for the second most recent run of the first test case, determining the first most recent run of the first test case to be the second previous run of the first test case.

11. The computer system of claim 9, wherein the operations further comprise:
responsive to determining to discontinue runs of the first test case on the microprocessor, automatically generating, by the hardware exerciser, a second test case and initiating the microprocessor to iteratively perform a plurality of runs of the second test case.

12. The computer system of claim 8, wherein the operations further comprise:
responsive to determining that a specified duration of time for testing the microprocessor using the test cases has elapsed, discontinuing running the test cases on the microprocessor.

13. The computer system of claim 8, wherein the microprocessor is a microprocessor model.

14. The computer system of claim 8, wherein the microprocessor is a microprocessor chip.

15. A computer program product for variable-length runtime for a hardware exerciser, the computer program product comprising:
one or more computer-readable storage media; and
program instructions stored on the one or more storage media to perform operations comprising:
initiating, by the hardware exerciser, a microprocessor to iteratively perform a plurality of runs of a first test case;
for each of the plurality of runs of the first test case, determining at least a first performance metric indicating a respective performance of the microprocessor for the respective run of the first test case;
responsive to completion of each of the plurality of respective runs of the first test case subsequent to a first run of the first test case, determining a difference between the at least the first performance metric determined for a most recent run of the first test case and the at least the first performance metric determined for a previous run of the first test case; and
for a first most recent run of the first test case, responsive to the difference, between the at least the first performance metric determined for the first most recent run of the first test case and the at least the first performance metric determined for a first previous run of the first test case, being greater than a first threshold value, continuing running the first test case on the microprocessor.

16. The computer program product of claim 15, wherein the operations further comprise:
for a second most recent run of the first test case, responsive to the difference, between the at least the first performance metric determined for the second most recent run of the first test case and the at least the first performance metric determined for a second previous run of the first test case, not being greater than the first threshold value, discontinuing runs of the first test case on the microprocessor.

17. The computer program product of claim 16, wherein the operations further comprise:
for the second most recent run of the first test case, determining the first most recent run of the first test case to be the second previous run of the first test case.

18. The computer program product of claim 16, wherein the operations further comprise:
responsive to determining to discontinue runs of the first test case on the microprocessor, automatically generating, by the hardware exerciser, a second test case and initiating the microprocessor to iteratively perform a plurality of runs of the second test case.

19. The computer program product of claim 18, wherein the operations further comprise:
responsive to determining that a specified duration of time for testing the microprocessor using the test cases has elapsed, discontinuing running the test cases on the microprocessor.

20. The computer program product of claim 15, wherein the microprocessor is a microprocessor model or a microprocessor chip.
